(19) United States
(12) Patent Application Publication
(10) Pub. No.: US 2007/0274901 A1
(43) Pub. Date: Nov. 29, 2007

(54) PROCESSES AND APPARATUS FOR THE PRODUCTION OF CHLORINE BY GAS PHASE OXIDATION

(75) Inventors: Aurel Wolf, Wulfrath (DE); Leslaw Mleczko, Dormagen (DE); Stephan Schubert, Leverkusen (DE); Oliver Felix-Karl Schluter, Leverkusen (DE)

Correspondence Address: CONNOLLY BOVE LODGE & HUTZ, LLP, P O BOX 2207, WILMINGTON, DE, 19899, US

(73) Assignee: Bayer Material Science AG

(21) Appl. No.: 11/752,676

(22) Filed: May 23, 2007

(30) Foreign Application Priority Data
May 23, 2006 (DE) 102006024521.0
Apr. 26, 2007 (DE) 102007020140.2

(51) Int. Cl. C01B 7/04; B01J 8/04

(52) U.S. Cl. 423/502; 422/188

(57) ABSTRACT

The present invention provides a process for producing chlorine by the catalytic gas phase oxidation of hydrogen chloride with oxygen, wherein the reaction is performed on at least two catalyst beds under adiabatic conditions, as well as a reactor system for performing the process.

### BACKGROUND OF THE INVENTION

A basic process for the catalytic oxidation of hydrogen chloride with oxygen in an exothermic equilibrium reaction, developed by Deacon in 1868, was devised at the very beginning of industrial chlorine chemistry:
4HCl+O₂⇄2Cl₂+2H₂O

However, chloroalkali electrolysis pushed the Deacon process right into the background. A significant amount of chlorine production was achieved using the electrolysis of aqueous common salt solutions. The attractiveness of the Deacon process has increased in more recent times, however, because the worldwide requirement for chlorine is growing more strongly than the demand for caustic soda solution, an associated by-product from electrolysis processes. A process for producing chlorine by the oxidation of hydrogen chloride that is independent of the production of caustic soda solution, such as a Deacon process, fits in with this development. In addition, the hydrogen chloride reactant needed for such oxidation processes is readily available as it is produced in large amounts, for example during phosgenation reactions, as an associated product from isocyanate production.

The dissipation and use of the heat of reaction is an important aspect of carrying out a Deacon process. An uncontrolled rise in temperature, that can amount to 600 to 900° C. from start to finish of the Deacon reaction, can lead on the one hand to permanent damage to the catalyst and, on the other hand, to an unfavourable shift of the reaction equilibrium in the direction of the feedstocks at high temperatures, with a corresponding impairment in the yield. Therefore, it is advantageous to keep the temperature of the catalyst bed during the course of the reaction within the range 150 to 600° C.

In known Deacon processes, a fluidised, thermally stabilised bed of catalyst can be used. In a known Deacon process, the catalyst bed is held at constant temperature via the outer wall of the reactor. In another known Deacon process the fluidised catalyst bed is held at constant temperature via a heat exchanger located within the bed. The effective removal of heat in such a process can be balanced against problems that can result from non-uniform distribution of residence times and catalyst abrasion, both of which lead to losses in conversion.

Narrow distribution of residence times and low catalyst abrasion are possible in reactors with fixed catalyst beds. However, problems with maintaining a constant temperature in the catalyst beds can arise in such reactors. Thermostated, multitube-flow reactors are generally used as a result, but these reactors usually have a very costly cooling circuit, particularly in the case of large reactors.

In order to improve the removal of heat from the catalyst bed, the use of a fixed-bed catalyst made of ruthenium oxide on titanium oxide as support has been suggested. In addition to the high catalyst activity, the good thermal conductivity of the catalyst system is a suggested advantage. However, even in the event of high thermal conductivity within the catalyst pellets, since the thermal conductivity of the bed can still be low, the removal of heat is not substantially improved by such measures.

The use of catalyst packings, in multitube-flow reactors, having different activities in each of the different regions of the cooled contact tube has also been suggested. In this way, progress of the reaction is to be slowed down sufficiently for the heat of reaction being produced to be more easily be removed via the wall of the contact tube. A similar result should be achieved by targeted dilution of the catalyst bed with an inert material. The disadvantages of such a process are that two or more catalyst systems have to be developed and used in the contact tubes and that the capacity of the reactor is impaired by the use of an inert material.

The possibility of the adiabatic catalytic oxidation of hydrogen chloride is mentioned in general terms in WO 2004/037718 and WO 2004/014845, the entire contents of each of which are incorporated herein by reference. No specific embodiment of an adiabatically managed hydrogen chloride oxidation is described in detail. Thus, it is not at all clear how the heat of reaction can be removed from the exothermic reaction and how damage to the catalyst can be avoided in such an adiabatic procedure.

The oxidation of hydrogen chloride has preferably been carried out isothermally, however, as a fixed-bed process in multitube-flow reactors that, as mentioned above. Such processes require a cooling system that is extremely costly to regulate. Generally, the multitube-flow reactors described are also very complex and demand high investment costs. Problems with regard to mechanical strength and uniform thermostating of the catalyst bed can increase rapidly with the size of the structure and can make large units of equipment of this type uneconomic.

Catalysts initially used for the Deacon process, for example supported catalysts containing the active substance CuCl₂, generally have only low activities. Although the activity could be increased by raising the reaction temperature, a disadvantage is that the volatility of the active component can lead to rapid deactivation of the catalyst at elevated temperature. In addition, the oxidation of hydrogen chloride to give chlorine is an equilibrium reaction. The position of the equilibrium shifts with increasing temperature, to the disadvantage of the desired end product.

Therefore, catalysts with the highest possible activity have generally been used more recently in gas phase oxidation of hydrogen chloride, allowing the reaction to proceed at a lower temperature. Known highly active catalysts are based on ruthenium. Supported catalysts containing the active substance ruthenium oxide or a ruthenium mixed oxide have been used. In such catalysts, the concentration of ruthenium oxide can be 0.1 wt. % to 20 wt. % and the average particle diameter of ruthenium oxide can be 1.0 nm to 10.0 nm. The reaction can be performed using such catalysts at a temperature between 90° C. and 150° C. Other supported catalysts based on ruthenium have been disclosed and include ruthenium chloride catalysts that contain at least one compound of titanium oxide or zirconium oxide, ruthenium-carbonyl complexes, ruthenium salts of inorganic acids, ruthenium-nitrosyl complexes, ruthenium-amine complexes, ruthenium complexes of organic amines or ruthenium-acetylacetonate complexes. The reaction can be performed at a temperature between 100° C. and 500° C. Such catalysts can be used in a fixed-bed or a fluidised bed. Air or pure oxygen can be used as the oxygen starting substance. However, the Deacon reaction is an exothermic reaction and temperature control is required, even when using such highly active catalysts.

A simple process that can be performed in a simple reactor without a costly system for managing the heat in the reactor would therefore be desirable. Such processes and reactors should be easy to transfer to an industrial scale and be inexpensive and robust, whatever the size. The enthalpy of reaction would be reflected quantitatively, in this type of reactor, in the temperature difference between the feedstock gas stream(s) and the product gas stream(s).

However, such reactors and simple processes have not been described, nor have suitable catalysts and suitable processes been demonstrated, for the exothermic gas phase oxidation of hydrogen chloride with an oxygen-containing gas stream.

Thus, providing a process for the catalytic oxidation of hydrogen chloride to give chlorine that can be performed in a simple reactor without a complex system for heat management in the reactor is desirable.

### BRIEF SUMMARY OF THE INVENTION

Surprisingly, the present inventors have found that a process for the catalytic oxidation of hydrogen chloride to give chlorine that can be performed in a simple reactor without a complex system for heat management in the reactor can be achieved by performing the reaction on at least two catalyst beds under adiabatic conditions.

The present invention relates, in general, to processes for producing chlorine by the catalytic gas phase oxidation of hydrogen chloride with oxygen, wherein the reaction is performed on at least two catalyst beds under adiabatic conditions, as well as reactor systems for performing the processes.

One embodiment of the present invention includes a process comprising reacting hydrogen chloride and oxygen on at least two catalyst beds, wherein the reaction of the hydrogen chloride and the oxygen on the at least two catalyst beds is carried out under adiabatic conditions. In various preferred embodiments, the reaction is preferably performed on at least two catalyst beds connected in series.

In addition to oxygen and hydrogen chloride, gas mixtures subjected to gas phase oxidation of hydrogen chloride in accordance with the various embodiments of the present invention may also include other secondary constituents, e.g., nitrogen, carbon dioxide, carbon monoxide or water. The hydrogen chloride gas mixture subjected to gas phase oxidation may arise from an upstream production process, e.g., for producing polyisocyanates, and may contain other impurities, e.g., phosgene.

Another embodiment of the present invention includes a reactor system comprising at least two adiabatically isolated, hydrogen chloride oxidation catalyst beds connected in series.

In accordance with the present invention, performing a process under adiabatic conditions on the catalyst beds means that substantially no heat is supplied to or removed from the catalyst in the relevant beds, from the outside (with the exception of the heat that is supplied or removed by the reaction gas entering and leaving). Such adiabatic conditions can be achieved, for example, by isolating the catalyst beds in a known manner including, but not limited to insulation. An essential feature of various process embodiments of the invention is that the individual catalyst beds are operated adiabatically, so that in particular no means for removing heat is provided in the catalyst beds. Considering processes according to the invention as a whole, it is to be understood that the removal of heat of reaction, for example using heat exchangers connected in series between individual catalyst beds, is encompassed so long as the catalyst beds themselves are operated adiabatically.

An advantage of adiabatic processes according to the invention, as compared to conventional isothermal procedures, is that mechanisms for the removal of heat do not have to be provided in the catalyst beds, and thus, considerable simplification of the process design and operation can be achieved in use. This additionally provides simplification when manufacturing reactor systems and when changing the scale of a process. As used herein, a catalyst bed is understood to be an arrangement of a catalyst in any manifestation known per se, e.g. fixed-bed, fluidized bed or moving bed. A fixed-bed arrangement is preferred. This includes a catalyst bed in the real sense, i.e. a loose, supported or unsupported catalyst in any form at all, as well as in the form of suitable packings.

### BRIEF DESCRIPTION OF THE SEVERAL VIEW OF THE DRAWINGS

The foregoing summary, as well as the following detailed description of the invention, will be better understood when read in conjunction with the appended drawings. For the purpose of illustrating the invention, there is shown in the drawing an embodiment which is presently preferred. It should be understood, however, that the invention is not limited to the precise arrangements and instrumentalities shown.

In the Figs.:

FIG. 1 is a schematic representation of an apparatus and process flow design according to one embodiment of the present invention;

FIG. 2 is a schematic representation of an apparatus and process flow design according to another embodiment of the present invention;

FIG. 3 is a schematic representation of an apparatus and process flow design according to another embodiment of the present invention;

FIG. 4 is a schematic representation of an apparatus and process flow design according to another embodiment of the present invention.

### DETAILED DESCRIPTION OF THE INVENTION

As used herein, the singular terms “a” and “the” are synonymous and used interchangeably with “one or more” or “at least one.” Accordingly, for example, reference to “a gas” herein or in the appended claims can refer to a single gas or more than one gas. Additionally, all numerical values, unless otherwise specifically noted, are understood to be modified by the word “about.”

Fixed-bed reactors are preferably used in various embodiments of the present invention. Thus, while moving catalyst beds, such as fluidised beds or vortex beds, can be used, fixed-bed reactors are preferred. The guideline speed for gas in a catalyst bed in the case of embodiments using a fixed-bed is preferably 0.1 to 10 m/s.

In various preferred embodiments, at least one heat exchanger is located downstream of one of the catalyst beds. In locating the at least one heat exchanger downstream, it is outside of the adiabatic conditions of the catalyst bed from which it is downstream. More preferably, at least one, and even more preferably only one, heat exchanger is located downstream of each of the at least two catalyst beds.

According to the invention, the at least two catalyst beds may also be connected in series. Preferably, 2 to 12, and more preferably 2 to 8, catalyst beds can be used in series in the processes and apparatus according to the various embodiments of the invention. Most preferably, 3 to 8 catalyst beds are connected in series with each other.

The catalyst beds may be divided between one or several reactors. Arranging the catalyst beds in one reactor leads to a reduction in the number of units of equipment used. Thus, at least two catalyst beds can be disposed in a single reactor shell so long as the individual catalyst beds are adiabatically isolated from one another.

In addition, in various embodiments of the invention, one or more of the catalyst beds connected in series can be replaced or supplemented by one or more catalyst beds operating in a parallel manner. The use of catalyst beds connected in parallel can allow the exchange or topping up of these beds while maintaining overall operation.

A particularly preferred embodiment of a process according to the invention employs at least two catalyst beds connected in series. While, catalyst beds connected in parallel and in series may be combined with each other according to the invention, the processes according to the invention preferably have catalyst beds connected exclusively in series.

In embodiments in which parallel operation is are used, it is preferable that at most 5, more preferably up to 3, and most preferably up to 2 process lines, having catalyst beds connected in series, are connected in parallel operation. Accordingly, processes according to such embodiments of the invention can be operated with up to 60 catalyst beds.

Suitable reactors for use in various embodiments according to the invention include simple containers with one or more adiabatically isolated catalyst beds such as are described, for example, in Ullmanns Encyclopedia of Industrial Chemistry (Fifth, Completely Revised, Edition, vol. B4, pages 95-102, pages 210-216), the contents of which are incorporated herein by reference. Multitube-flow reactors, however, are preferably not used, according to the invention, due to the disadvantages described hereinabove. Since, according to the invention, removal of the heat does not take place from the catalyst beds, these types of reactors are also unnecessary for holding the catalyst beds.

Individual catalyst beds within such suitable reactors can be mounted, in a known manner, on or between gas-permeable partitions. In various embodiments of the present invention in which thin bed catalysts are employed, industrial devices for uniform distribution of gas can be mounted above, below or above and below the beds. Such devices include, but are not limited to, perforated plates, bubble-cap trays, valve trays or other baffles that bring about uniform entrance of the gas into the catalyst bed by producing a small, but uniform, pressure loss.

The term “catalyst bed”, as used herein, includes coherent regions of suitable packings on a support material or structured catalyst support. Suitable support materials include, but are not limited to, ceramic honeycomb structures with comparatively large geometric surface areas that are coated, or corrugated layers of metal gauze, on which are immobilised, for example, granules of catalyst.

In various preferred embodiments of processes according to the invention, a ratio of between 0.25 and 10 equivalents of oxygen to one equivalent of hydrogen chloride is used. By increasing the ratio of equivalents of oxygen to one equivalent of hydrogen chloride, on the one hand the reaction can be accelerated and thus the space-time yield (amount of chlorine produced per reactor volume) can be increased and, on the other hand, the equilibrium of the reaction can be shifted positively in the direction of the products.

In various preferred embodiments of processes according to the invention, the inlet temperature of the gas mixture entering the first catalyst bed is 150 to 400° C., preferably 200 to 370° C.

Feedstock gas streams for use in the processes according to the present invention comprise hydrogen chloride and oxygen. A feedstock gas stream may preferably be introduced only upstream of the first catalyst bed, Introduction to the “first catalyst bad” can include feeding the gas stream to a first catalyst bed where two or more beds are arranged in series, and/or feeding a gas stream to two parallel beds operating in place of such a first bed in a series. It is also possible, where desirable or required, to meter hydrogen chloride and/or oxygen, and/or any other additional process gas, into the gas stream upstream of one or more of the catalyst beds following the first catalyst bed. In addition, the overall temperature of reaction can be controlled by supplying fresh gas feed to a process stream between the catalyst beds being used.

In a particularly preferred embodiment of a process according to the invention, the reaction gas is cooled after exiting at least one of the catalyst beds, particularly preferably after exiting each of the catalyst beds. For this purpose, the reaction gas can be passed through one or more heat exchangers that are located downstream of the relevant catalyst beds. Suitable heat exchangers include, but are not limited to, heaters familiar to a person skilled in the art such as, e.g., shell-and-tube, parallel plate, annular groove, spiral, fin-tube or micro heat exchangers. In various preferred embodiments of processes according to the invention, steam can be produced when cooling a process gas in the heat exchangers.

The terms “process gas,” “reaction gas,” “process stream,” and “reaction stream” are generally used herein interchangeably and can refer generally to a feedstock gas or gas stream regardless of where it's introduced, and/or an intermediate gas or gas stream exiting a catalyst bed or entering a heat exchanger, and/or a final gas product exiting the process, unless context and specific language dictate otherwise.

In various preferred embodiments of the process, the catalyst beds connected in series can be operated with mean temperatures that increase or decrease from catalyst bed to catalyst bed. This means that the temperature may be allowed to either rise or sink from catalyst bed to catalyst bed within a sequence of catalyst beds. Thus, it may be particularly advantageous initially to allow the mean temperature to rise from catalyst bed to catalyst bed in order to increase the catalyst activity and then to allow the mean temperature to drop again in the subsequent final beds, in order to shift the equilibrium. This can be adjusted, for example, via the control system for the heat exchangers located between the catalyst beds. Further possibilities for adjusting the mean temperature are described below.

In a preferred secondary step in the inventive processes, the chlorine formed is separated. The separation generally includes several stages, that is the separation and optionally the recycling of unreacted hydrogen chloride from the product gas stream for catalytic oxidation of hydrogen chloride, drying of the stream containing substantially chlorine and oxygen and the separation of chlorine from the dried stream.

The separation of unreacted hydrogen chloride and of water vapour that is formed can be achieved by condensing out aqueous hydrogen chloride from the product gas stream for the oxidation of hydrogen chloride by cooling. Hydrogen chloride may also be absorbed in dilute hydrochloric acid or water.

In a preferred embodiment of a process according to the invention, unreacted hydrogen chloride gas and/or oxygen can be recycled to the reaction, after separating chlorine and water from the product stream and after diverting a small amount of the gas in order to keep constant the gaseous components that may be entrained with the feedstocks. The recycled hydrogen chloride and/or oxygen can be reintroduced upstream of one or more catalyst beds. Preferably, the gases are first returned to the inlet temperature of the process, optionally using a heat exchanger. Cooling of the product gas and heating of the recycled hydrogen chloride and/or oxygen is advantageously achieved by running the gas streams past each other in counterstream through heat exchangers.

The processes according to the invention are preferably operated at pressures between 1 and 30 bar, more preferably between 1 and 20 bar, particularly preferably between 1 and 15 bar The pressures in the various catalyst beds may vary independently of one another.

The temperature of the reaction gas mixture upstream of each of the catalyst beds is preferably between 150 and 350° C., more preferably between 200 and 320° C., particularly preferably between 250 and 300° C. The temperatures of the process gases in the various catalyst beds may vary independently of one another.

The thickness of the catalyst beds being traversed are chosen to be identical or different and are generally between 1 cm and 8 m, preferably between 5 cm and 5 m, particularly preferably between 30 cm and 2.5 m.

The catalyst is preferably used immobilised on a support. The catalyst preferably contains at least one of the following elements: copper, potassium, sodium, chromium, cerium, gold, bismuth, ruthenium, rhodium, platinum, as well as the elements from Group VIII. These are preferably used as oxides or halides, in particular chlorides. These elements or compounds thereof may be used individually or combined with each other.

Preferred compounds of these elements include: copper chloride, copper oxide, potassium chloride, sodium chloride, chromium oxide, bismuth oxide, ruthenium oxide, ruthenium chloride, ruthenium oxychloride, rhodium oxide.

The catalyst component particularly preferably consists entirely or partly of ruthenium or compounds thereof; the catalyst particularly preferably comprises halide and/or oxygen-containing ruthenium compounds.

The support component may consist entirely or partly of: titanium oxide, tin oxide, aluminium oxide, zirconium oxide, vanadium oxide, chromium oxide, silicon oxide, silica, carbon nanotubes or a mixture or compound of the substances mentioned, such as in particular mixed oxides such as silicon-aluminium oxides. Particularly preferred support materials are tin oxide and carbon nanotubes.

Ruthenium supported catalysts may be obtained, for example, by soaking the support material with aqueous solutions of RuCl₃ and optionally a promoter for doping purposes. The catalyst can be molded into shape after or, preferably, before soaking the support material.

Promoters that are suitable for doping the catalyst are alkali metals such as lithium, sodium, potassium, rubidium and caesium, preferably lithium, sodium and potassium, particularly preferably potassium, alkaline earth metals such as magnesium, calcium strontium and barium, preferably magnesium and calcium, particularly preferably magnesium, rare earth metals such as scandium, yttrium, lanthanum, cerium, praseodymium and neodymium, preferably scandium, yttrium, lanthanum and cerium particularly preferably lanthanum and cerium, or mixtures of these.

The molded items may then be dried and optionally calcined at a temperature of 100 to 400° C., preferably 100 to 300° C., under an atmosphere of for example nitrogen, argon or air. The molded items are preferably first dried at 100 to 150° C. and then calcined at 200 to 400° C.

The temperature of the catalyst in the catalyst beds is expediently within a range of 150° C. to 800° C., preferably 200° C. to 450° C., particularly preferably 250° C. to 400° C. The temperature in the catalyst beds is preferably regulated by at least one of the following measures: appropriate sizing of the catalyst beds, regulating the removal of heat between the catalyst beds, supplying the feedstock gases between the catalyst beds, molar ratio of the feedstocks, concentrations of the feedstocks.

In principle, the catalysts and supported catalysts may have any shape at all, e.g., beads, rods, Raschig rings or granules or tablets.

The composition of the catalysts in the catalyst beds used according to the invention may be identical or different. In a preferred embodiment identical catalysts are used in each bed. However, different catalysts may also advantageously be used in the individual beds. Thus, a less active catalyst may be used in particular in the first bed when the concentration of the reaction products is rather high, and the activity of the catalyst may then be increased from bed to bed in the further beds. The catalyst activity may also be controlled by diluting with inert materials or support material.

Using a process according to the invention, 0.1 g/h to 10 g/h of chlorine, preferably 0.5 g/h to 5 g/h of chlorine, can be produced per 1 g of catalyst. A process according to the invention is thus characterised by high space-time yields, associated with a reduction in the size of the equipment used and also simplification of the equipment or the reactors.

A suitable feedstock for use in a process according to the invention is hydrogen chloride that has been produced and transferred e.g., as an associated product during the phosgenation of organic amines, in particular diamines, to give isocyanates, in particular diisocyanates, or during the gas phase phosgenation of phenyl to give diphenyl carbonate.

Oxygen may be supplied as pure oxygen or, preferably, in the form of an oxygen-containing gas, in particular air.

The chlorine produced may be used e.g., to produce phosgene, and optionally recycled to linked production processes.

The invention also provides a reactor system for reacting a gas that contains hydrogen chloride and oxygen, containing at least pipework for hydrogen chloride and oxygen or for a mixture of hydrogen chloride and oxygen and at least two thermally isolated catalyst beds connected in series

The following examples, referring to FIGS. 1-4, are for reference and do not limit the invention described herein.

### EXAMPLES

Numbering used in the figures:
1 Hydrogen chloride (feedstock)
2 Oxygen (feedstock)
3 Mixed feedstock gas stream
4, 5, 6 Product gases from the reactors
7, 8, 9 Product gases cooled by heat exchangers
10 Hydrogen chloride (from product gas)
11 Oxygen (from product gas)
12 Chlorine
13 Water
14, 16, 18 Cooling medium supply
15, 17, 19 Cooling medium discharge
20, 21 Supply of fresh feedstock gas (hydrogen chloride and/or oxygen)
22 Recycled hydrogen chloride and/or oxygen separated from the product gas
I, II, III Reactor beds
IV, V, VI Heat exchangers
VII Material separation for product stream, e.g., in accordance with known procedures

### Example 1

FIG. 1 shows a process according to one embodiment of the invention with three catalyst beds in series divided between three separate reactors. The feedstock gases are mixed upstream of the first reactor and supplied to the reactor. After each of the reactors, the emerging reaction gas is cooled using a shell-and-tube heat exchanger of the conventional type. After emerging from the third heat exchanger, chlorine and water are separated from the product gas.

### Example 2

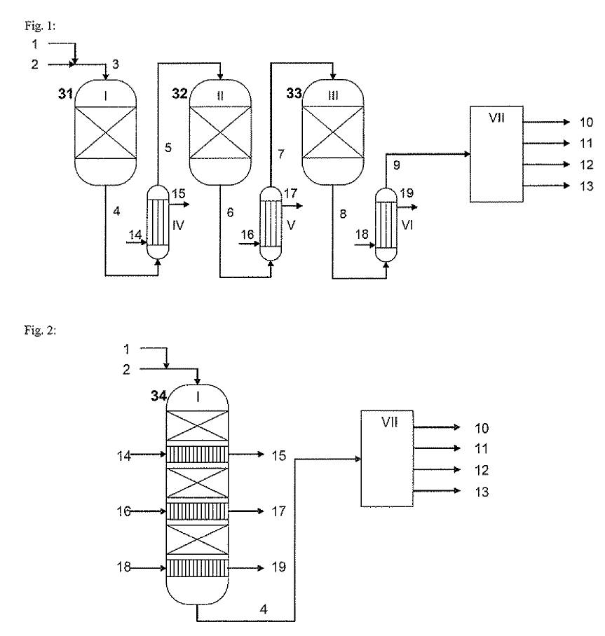

FIG. 2 shows a process according to another embodiment of the invention with three catalyst beds in series in an integrated reactor. The feedstock gases are mixed upstream of the reactor and fed to this reactor. Following each of the catalyst beds, the emerging process gas is cooled using a heat exchanger also integrated in the pressurised container for the reactor. After emerging from the reactor, chlorine and water are separated from the product gas.

### Example 3

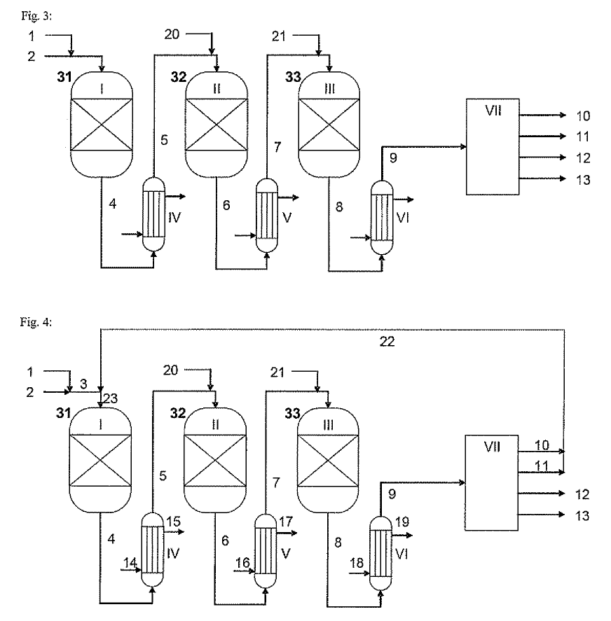

FIG. 3 shows a process according to another embodiment of the invention with a layout that corresponds by and large to the one shown in FIG. 1. The difference is that, upstream of the second and third reactors in series, fresh feedstock gas is introduced into the cooled process gas from the preceding reactor.

### Example 4

FIG. 4 shows a process according to another embodiment of the invention with a layout that corresponds by and large to the one shown in FIG. 3. The difference is that the hydrogen chloride and oxygen separated from the product gas stream are recycled and admixed with the feedstock gas stream upstream of the first reactor.

### Example 5

Chlorine was produced by the catalytic gas phase oxidation of hydrogen chloride with oxygen in an experimental plant. Calcined ruthenium chloride on tin dioxide as support material was used as the catalyst. The experimental plant consisted of six reactors connected in series, each with a thermally isolated catalyst bed. A heat-exchanger was located between each of the reactors, that is a total of five, that cooled the gas stream emerging from each of the relevant upstream reactors to the inlet temperature required for each of the relevant downstream reactors. Oxygen (29 kg/h), together with nitrogen (25 kg/h) and carbon dioxide (13.5 kg/h), was heated to about 305° C. using an electrical preheater and then introduced to the first reactor. The hydrogen chloride (47.1 kg/h) was heated to about 150° C. and then divided into a total of 6 substreams. One of each of these substreams was supplied to each reactor, wherein, in the first reactor, the hydrogen chloride substream was added to the gas stream consisting of oxygen, nitrogen and carbon dioxide, in between the electrical preheater and the reactor inlet. Each of the other hydrogen chloride substreams was added to the gas stream upstream of one of the five heat-exchangers. Table 1 shows the temperature of the gas mixture introduced to and emerging from all six reactors as well as the amount of hydrogen chloride supplied to each reactor. The total conversion of hydrogen chloride was 82.4%.

TABLE 1

| | Hydrogen chloride | | Outlet |
|---|---|---|---|
| | substream | Inlet temperature | temperature |
| Reactor number | [kg/h] | [° C.] | [° C.] |
| 1 | 10.5 | 290.4 | 381.0 |
| 2 | 7.3 | 321.5 | 377.0 |
| 3 | 6.7 | 332.8 | 379.3 |
| 4 | 7.0 | 332.2 | 376.7 |
| 5 | 8.2 | 332.0 | 373.1 |
| 6 | 7.4 | 332.9 | 367.5 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising reacting hydrogen chloride and oxygen on at least two catalyst beds, wherein the reaction of the hydrogen chloride and the oxygen on the at least two catalyst beds is carried out under adiabatic conditions.

2. The process according to claim 1, wherein the at least two catalyst beds are connected in series.

3. The process according to claim 1, wherein the at least two catalyst beds are adiabatically isolated from each other.

4. The process according to claim 2, wherein the at least two catalyst beds are adiabatically isolated from each other.

5. The process according to claim 1, wherein each of the at least two catalyst beds independently has a catalyst temperature of 150° C. to 800° C.

6. The process according to claim 2, wherein each of the at least two catalyst beds independently has a catalyst temperature of 150° C. to 800° C.

7. The process according to claim 4, wherein each of the at least two catalyst beds independently has a catalyst temperature of 150° C. to 800° C.

8. The process according to claim 1, wherein at least one heat exchanger is located downstream of at least one of the at least two catalyst beds, the process further comprising adjusting the temperature of a process stream in the heat exchanger, the process stream being supplied to the at least one heat exchanger from the at least one catalyst bed.

9. The process according to claim 4, wherein at least one heat exchanger is located downstream of at least one of the at least two catalyst beds, the process further comprising adjusting the temperature of a process stream in the heat exchanger, the process stream being supplied to the at least one heat exchanger from the at least one catalyst bed.

10. The process according to claim 1, wherein at least one heat exchanger is located downstream of each of the at least two catalyst beds, the process further comprising adjusting the temperature of a process stream in the at least one heat exchanger located downstream of each of the at least two catalyst beds, the process stream being supplied to the at least one heat exchanger from the respective upstream catalyst bed.

11. The process according to claim 4, wherein at least one heat exchanger is located downstream of each of the at least two catalyst beds and upstream of the next catalyst bed in the series, the process further comprising adjusting the temperature of a process stream in the at least one heat exchanger located downstream of each of the at least two catalyst beds, the process stream being supplied to the at least one heat exchanger from the preceding upstream catalyst bed.

12. The process according to claim 8, wherein the temperature is lowered in the at least one heat exchanger and steam is produced.

13. The process according to claims 1, wherein the reaction of the hydrogen chloride and the oxygen on each of the at least two catalyst beds is independently carried out at a pressure of 1 to 30 bar.

14. The process according to claims 11, wherein the reaction of the hydrogen chloride and the oxygen on each of the at least two catalyst beds is independently carried out at a pressure of 1 to 30 bar.

15. The process according to claim 1, wherein the hydrogen chloride and the oxygen are introduced to each of the catalyst beds at an inlet temperature, independent of one another, of 150 to 350° C.

16. The process according to claim 2, wherein the hydrogen chloride and the oxygen are introduced to the first of the two catalyst beds in series at an inlet temperature, independent of one another, of 150 to 350° C.

17. The process according to claim 1, wherein the hydrogen chloride and the oxygen are introduced to the first of the two catalyst beds in series at an inlet temperature, independent of one another, of 150 to 350° C.

18. The process according to claim 1, wherein the oxygen and the hydrogen chloride are present in the process in an overall molar ratio of 0.25:1 to 10:1.

19. The process according to one of claim 1, wherein the reaction of the hydrogen chloride and the oxygen is carried out on 2 to 12 catalyst beds connected in series.

20. The process according to claim 19, wherein one or more of the 2 to 12 catalyst beds in the series is substituted with two or more catalyst beds operating in parallel.

21. The process according to claim 11, wherein one or more of the at least two catalyst beds in the series is substituted with two or more catalyst beds operating in parallel.

22. The process according to claim 1, wherein the hydrogen chloride and the oxygen are supplied as a single inlet gas stream upstream of the first of the at least two catalyst beds.

23. The process according to claim 11, wherein the hydrogen chloride and the oxygen are supplied as a single inlet gas stream upstream of the first of the at least two catalyst beds.

24. The process according to claim 1, wherein either or both the hydrogen chloride and the oxygen is introduced into the process upstream of each of the at least two catalyst beds.

25. The process according to claim 11, wherein either or both the hydrogen chloride and the oxygen is introduced into the process upstream of each of the at least two catalyst beds.

26. The process according to claim 1, wherein each of the at least two catalyst beds has a catalyst depth of 1 cm to 8 m.

27. The process according to claim 1, wherein each of the at least two catalyst beds comprises a catalyst having at least one element selected from the group consisting of copper, potassium, sodium, chromium, cerium, gold, bismuth, ruthenium, rhodium, platinum and Group VIII elements.

28. The process according to claim 11, wherein each of the at least two catalyst beds comprises a catalyst having at least one element selected from the group consisting of copper, potassium, sodium, chromium, cerium, gold, bismuth, ruthenium, rhodium, platinum and Group VIII elements.

29. The process according to claim 1, each of the at least two catalyst beds comprises a ruthenium catalyst.

30. The process according to claim 1, wherein the at least two catalyst beds have different catalyst activities.

31. The process according to claim 1, wherein the at least two catalyst beds comprise a catalyst immobilised on an inert support.

32. The process according to claim 11, wherein the at least two catalyst beds comprise a catalyst immobilised on an inert support.

33. The process according to claim 32, wherein each of the at least two catalyst beds comprises a catalyst having at least one element selected from the group consisting of copper, potassium, sodium, chromium, cerium, gold, bismuth, ruthenium, rhodium, platinum and Group VIII elements.

34. A reactor system comprising at least two adiabatically isolated, hydrogen chloride oxidation catalyst beds connected in series.
